(19) United States
(12) Patent Application Publication
(10) Pub. No.: US 2011/0247049 A1
(43) Pub. Date: Oct. 6, 2011

(54) ELECTRONIC DOCUMENT SECURITY SYSTEM AND METHOD

(75) Inventors: CHUNG-I LEE, Tu-Cheng (TW); HAI-HONG LIN, Shenzhen City (CN); XIAO-DI FAN, Shenzhen City (CN); YUE-HAI YI, Shenzhen City (CN); GANG XIONG, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 13/052,123

(22) Filed: Mar. 21, 2011

(30) Foreign Application Priority Data
Mar. 30, 2010 (CN) 201010135541.7

(51) Int. Cl. G06F 21/00; G06F 15/16

(52) U.S. Cl. 726/3

(57) ABSTRACT

An electronic document security method receives a user request for viewing an electronic document from a client device. If the user request is approved, the electronic document is retrieved from a storage system. The electronic document is converted into an image format, and is output to the client computer.

### BACKGROUND

1. Technical Field

Embodiments of the present disclosure relate to electronic documents, and particularly to an electronic document security system and method.

2. Description of Related Art

Electronic documents, such as electronic contracts or orders, are widely used in paperless offices. The electronic documents may be editable. Therefore, users may modify the electronic documents by accident while viewing the electronic documents.

### BRIEF DESCRIPTION OF THE DRAWINGS

FIG. 1 shows an application environment of one embodiment of an electronic document security system.

FIG. 2 is a block diagram of a security unit of the electronic document security system of FIG. 1.

FIG. 3 is a flowchart of one embodiment of an electronic document security method implementing a system, such as that of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

In general, the word “module,” as used hereinafter, refers to logic embodied in hardware or firmware, or to a collection of software instructions, written in a programming language, such as, for example, Java, C, or Assembly. One or more software instructions in the modules may be embedded in firmware. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

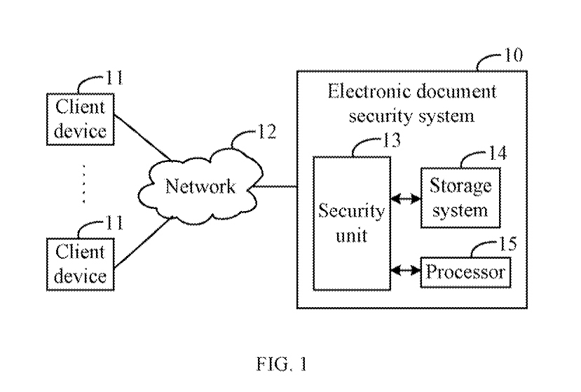

FIG. 1 shows an application environment of one embodiment of an electronic document security system 10 (hereinafter referred to as “the system 10”). In one embodiment, the electronic documents can be in a PDF, DOC, or XLS format and thus are editable files. The system 10 is in electronic communication with at least one client device 11 over a network 12. The client device 11 sends user requests to the system 10 to view the electronic documents. The client device 11 may be a personal computer, a mobile phone, or a personal digital assistant (PDA), for example. The network 12 may be an intranet, such as a local area network (LAN) within a company or an extranet, such as the Internet. The electronic documents may be electronic contracts or electronic orders, for example.

In one embodiment, the system 10 may include a security unit 13, a storage system 14, and at least one processor 15. The storage system 14 may include a database storing the electronic documents. The security unit 13 includes a number of function modules. The function modules may comprise computerized codes in the form of one or more programs stored in the storage system 14. The computerized code includes instructions executed by the at least one processor 15 to provide functions for the modules. In one embodiment, the storage system 14 may be an internal storage device, such as a random access memory (RAM) for temporary storage of information, and/or a read only memory (ROM) for permanent storage of information. In some embodiments, the storage system 14 may also be an external storage device, such as an external hard disk, a storage card, or a data storage medium.

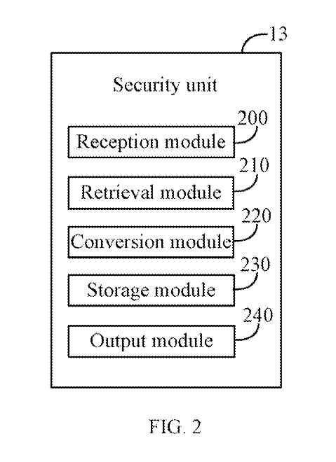

FIG. 2 is a block diagram of the security unit 13 of the system 10 of FIG. 1. In one embodiment, the security unit 13 may include a reception module 200, a retrieval module 210, a conversion module 220, a storage module 230, and an output module 240.

The reception module 200 is operable to receive a user request for viewing an electronic document from the client device 11. For example, the reception module 200 can receive a user request for viewing an electronic document with a document ID “0010101.” In one embodiment, the reception module 200 provides a user interface, such as a webpage, for a user to enter the user request. The user request may include a document name or a document ID of the electronic document to be viewed by the user.

The retrieval module 210 is operable to examine the user request and reward approval or rejection to the user request. The retrieval module 210 is further operable to retrieve the electronic document from the storage system 14 if the user request is approved. In one example, the retrieval module 210 determines whether the user request is approved by checking whether the document name of the electronic document matches one of the document names of the electronic documents stored in the storage system 14. If the document name of the electronic document matches one of the document names of the electronic documents stored in the storage system 14, the retrieval module 210 determines that the user request is approved, and retrieves the electronic document from the storage system 14 according to the document name of the electronic document.

The conversion module 220 is operable to convert the electronic document into an image format. The image format is not editable. Thus, the electronic document cannot be modified after conversion. In one example, the electronic document is originally in a DOC or XLS format, which are editable formats. In such a case, the conversion module 220 can convert the electronic document into non-editable formats, such as the JPG format or GIF format.

The storage module 230 is operable to store the converted electronic document into the storage system 14. In one embodiment, the storage module 230 stores the converted electronic document into the database of the storage system 14.

The output module 240 is operable to output the converted electronic document to the client device 11. Therefore, the user can view the electronic document on a display screen of the client device 11 without risk of modifying the electronic document by accident.

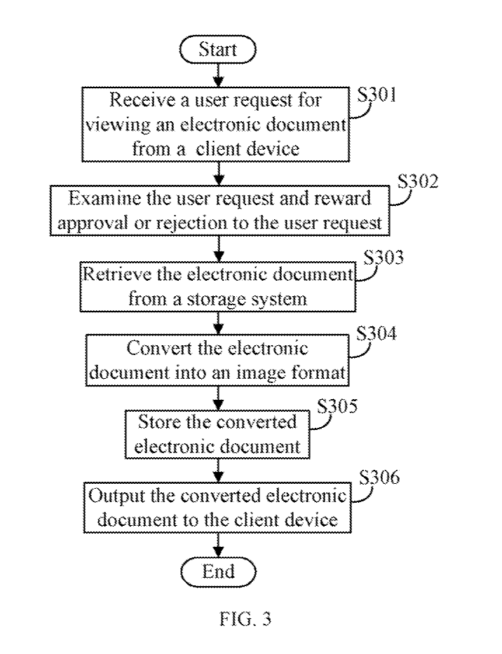

FIG. 3 is a flowchart of one embodiment of an electronic document security method implementing a system, such as that of FIG. 1. Depending on the embodiments, additional blocks may be added, others removed, and the ordering of the blocks may be changed.

In block S301, the reception module 200 receives a user request for viewing an electronic document from the client device 11. In one embodiment, the reception module 200 provides a user interface, such as a webpage for users to enter the user request. The user request may include a document name or a document ID of the electronic document to be viewed by the user.

In block S302, the retrieval module 210 examines the user request and rewards approval or rejection to the user request. In one example, the retrieval module 210 determines whether the user request is approved by checking whether the document name of the electronic document matches one of the document names of the electronic documents stored in the storage system 14. If the document name of the electronic document matches one of the document names of the electronic documents stored in the storage system 14, the retrieval module 210 determines that the user request is approved.

If the user request is approved, in block S303, the retrieval module 210 retrieves the electronic document from the storage system 14. In one example, the retrieval module 210 retrieves the electronic document according to a document name or a document ID of the electronic document.

In block S304, the conversion module 220 converts the electronic document into an image format. In one embodiment, the electronic document is originally in a text format, such as DOC or XLS format, which are editable formats. In such a case, the conversion module 220 can convert the electronic document from the text format into non-editable formats, such as the JPG format or a GIF format.

In block S305, the storage module 230 stores the converted electronic document into the storage system 14.

In block S306, the output module 240 outputs the converted electronic document to the client device 11. As such, the user can view the electronic document on a display screen of the client device 11 without risk of modifying the electronic document by accident.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic document security system, the system comprising:
a storage system storing one or more electronic documents;
at least one processor; and
one or more programs stored in the storage system and executable by the at least one processor, the one or more programs comprising:
a reception module operable to receive a user request sent from a client device, the user request requesting view an electronic document stored in the storage system;
a retrieval module operable to examine the user request and reward approval or rejection to the user request, and retrieve the electronic document from the storage system if the user request is approved;
a conversion module operable to convert the electronic document into an image format; and
an output module operable to output the converted electronic document to the client computer.

2. The system of claim 1, wherein the electronic document is in a PDF, DOC, or XLS format.

3. The system of claim 1, further comprising a storage module operable to store the converted electronic document into the storage system.

4. The system of claim 1, wherein the image format is JPG or GIF.

5. The system of claim 1, wherein the electronic document is an electronic contract or an electronic order.

6. An electronic document security method, comprising:
receiving a user request sent from a client device, the user request requesting view an electronic document stored in a storage system;
examining the user request and rewarding approval or rejection to the user request;
retrieving the electronic document from the storage system upon condition that the user request is approved;
converting the electronic document into an image format; and
outputting the converted electronic document to the client computer.

7. The method of claim 6, wherein the electronic document is in a PDF, DOC, or XLS format.

8. The method of claim 6, further comprising:
storing the converted electronic document into the storage system.

9. The method of claim 6, wherein the image format is JPG or GIF.

10. The method of claim 6, wherein the electronic document is an electronic contract or an electronic order.

11. A non-transitory computer-readable medium having stored thereon instructions that, when executed by at least one processor of a computerized device, causes the computerized device to execute an electronic document security method, the method comprising:
receiving a user request sent from a client device, the user request requesting view an electronic document stored in a storage system;
examining the user request and rewarding approval or rejection to the user request;
retrieving the electronic document from the storage system upon condition that the user request is approved;
converting the electronic document into an image format; and
outputting the converted electronic document to the client computer.

12. The medium of claim 11, wherein the electronic document is in a PDF, DOC, or XLS format.

13. The medium of claim 11, wherein the method further comprises:
storing the converted electronic document into the storage system.

14. The medium of claim 11, wherein the image format is JPG or GIF.

15. The medium of claim 11, wherein the electronic document is an electronic contract or an electronic order.
